(19) United States
(12) Patent Application Publication
(10) Pub. No.: US 2026/0318385 A1
(43) Pub. Date: Oct. 15, 2026

(54) ELECTROMAGNETIC VARIABLE-DAMPING LATCHING-BASED LONG-PERIOD VIBRATION CONTROL APPARATUS

(71) Applicant: THE HONG KONG POLYTECHNIC UNIVERSITY, Hong Kong (CN)

(72) Inventors: Songye ZHU, Hong Kong (CN); Hao WANG, Hong Kong (CN)

(21) Appl. No.: 19/688,645

(22) Filed: May 27, 2026

Related U.S. Application Data
(63) Continuation of application No. PCT/CN2024/124781, filed on Oct. 14, 2024.

(30) Foreign Application Priority Data
Nov. 29, 2023 (CN) 202311621850.9

(51) Int. Cl. F16F 15/18; F16F 15/00

(52) U.S. Cl. CPC F16F 15/18; F16F 15/002; F16F 2222/06

(57) ABSTRACT

The present application provides an electromagnetic variable-damping latching-based long-period vibration control apparatus, including a housing, a rotating shaft, a pendulum mass, a brake assembly, a data acquisition element, an electromagnetic variable-damping module, and a control module. The rotating shaft is rotationally connected to the housing; the pendulum mass is fixedly connected to the rotating shaft; the brake assembly is used for latching the rotating shaft; the data acquisition element is connected to the rotating shaft; the electromagnetic variable-damping module is connected to the rotating shaft; the control module is mounted on the housing and comprises a data processing unit and a controller; the data processing unit is electrically connected to the data acquisition element and used for obtaining the angular velocity of the pendulum mass; and the controller is electrically connected to the data processing unit, the brake assembly, and the electromagnetic variable-damping module respectively.

### CROSS-REFERENCE TO RELATED APPLICATIONS

The application is a continuation application of International Application No. PCT/CN2024/124781 with an international filing date of Oct. 14, 2024, designating the U.S., now pending, and claims priority to a Chinese patent application with the application number 202311621850.9, the title of the application is “ELECTROMAGNETIC VARIABLE-DAMPING LATCHING-BASED LONG-PERIOD VIBRATION CONTROL APPARATUS”, which was filed in the China Patent Office on Nov. 29, 2023, and the entire content of the application is incorporated herein by reference.

### TECHNICAL FIELD

The application relates to the technical field of structural engineering, and in particular to an electromagnetic variable-damping latching-based long-period vibration control apparatus.

### BACKGROUND

Long-period vibration is a common vibration form in production and life. The long-period vibration, namely low-frequency vibration, has the significant feature of long vibration period. The existing art has poor control effect on the long-period vibration. Common long-period vibrations include the vibration of floating offshore engineering structures under waves, the swing vibration of an ultra-long pendulum, the vibration of super high-rise building structures, the vibration of large-span flexible structures, etc. The offshore engineering develops rapidly, and the installed capacity of offshore engineering structures such as offshore wind turbines, offshore platforms, and offshore photovoltaic power generation increases rapidly. Meanwhile, with the development of engineering technology, offshore engineering structures gradually move from offshore to deep sea, and floating offshore engineering structures have become a popular development direction. Floating offshore engineering structures have the advantages of being environmentally friendly, having little impact on the coastal environment, and having little impact on human life on land. Floating offshore structures are of great significance for resource extraction in deep and far seas. In addition, floating offshore wind turbines and photovoltaic power generation have the advantage of higher power generation efficiency compared with land and offshore. However, due to the complex marine environment, offshore engineering structures are subjected to complex coupled loads, such as waves, currents, ice, wind, earthquakes, etc. Structures will vibrate under loads, affecting the normal service of the structures, and even causing structural damage or failure. Among them, the wave load is the load that the floating offshore engineering structure continuously bears, and its period is relatively long, usually in the range of 6 -16 seconds. The floating structure will produce long-period vibration under the action of wave load, and the vibration period can be more than 100 seconds. Such long-period vibrations will adversely affect the normal service of the structure, and will cause structural fatigue problems, greatly reducing the reliability. Therefore, a technology is needed to effectively suppress the long-period vibration problem of offshore engineering structures. In addition, the long-period vibration problems of structures not only exist in offshore engineering structures, but is also relatively common in other types of structures, such as super high-rise building structures, large-span flexible structures, and ultra-long pendulum structures, and the like. However, traditional technologies are difficult to produce a good suppression effect on such long-period vibration problems.

In order to solve various problems caused by structural vibrations, eliminate or mitigate the vibrations caused by external loads, vibration control technology has been developed rapidly in recent years. Not only in the field of civil engineering, vibration control technology is also a hot research direction in the fields of aerospace, automobiles, machinery, offshore engineering, and the like. Properly installing a vibration control system in a structure can effectively reduce the dynamic response of the structure, reduce the damage or fatigue damage of the structure, so as to meet the needs of people for the safety and comfort of the structure, and achieve a reasonable balance of safety, economy and reliability. A large number of studies have shown that the application of vibration control technology in civil engineering has significant effect and important significance, it can not only prevent or mitigate the damage of the structure, improve the disaster prevention performance of the structure, ensure the safety of people's life and property, but also can prolong the service life of the structure, reduce the maintenance cost of the structure, and greatly meet the comfort requirements of people under extreme conditions.

Structural vibration control technology can be divided into the following four categories: active control, passive control, semi-active control, and hybrid control. Among them, the research of passive control technology has been relatively mature, and the passive control apparatus for energy absorption, such as tuned mass damper (TMD) have been applied in many civil engineering structures. The principle of TMD control is to adjust the frequency of the substructure, i.e. the damper, to be consistent or close to the main structure, i.e. the controlled structure, so that the substructure and the main structure resonate, the vibration energy of the main structure is dissipated through the internal damping mechanism of the substructure, thereby reducing the dynamic response of the main structure, and achieving the purpose of vibration control. However, it is difficult to adjust the frequency of the tuned mass damper to be consistent with the long-period vibration (low-frequency vibration) of the controlled structure, so it is difficult to produce a good suppression effect on the long-period vibrations. Even if the damper stroke is increased to extend the damper period according to theoretical design, it will lead to a huge damper volume, which is difficult to manufacture and install in practical engineering.

In addition, the period (frequency) of the structure is usually not fixed during the service process, for example, the pendulum structure, the pendulum crane changes the pendulum length during the use process, so the period changes. Other types of structures also change the period (frequency) during use. After a conventional passive control apparatus is designed and installed according to the structural period, its period (frequency) cannot be adjusted. Once the period (frequency) of the control apparatus, and the controlled structure are detuned, even if there is a small deviation, the control effect of the control apparatus will be greatly reduced. Some existing active and semi-active control technology can realize the period (frequency) adjustment to a certain extent, but the adjustment range is limited, and it cannot meet the needs of long-period vibration control. In addition, the existing passive vibration control technologies cannot realize the adjustment of damping, and the damping will change due to the long-term use of the damper, which will greatly reduce the control effect of the apparatus.

In summary, for the problem of long-period vibrations, the existing art mainly has the following five deficiencies: First, the existing art has a poor control effect on the long-period vibration of the structure; Second, even if the existing art has a certain control effect on the long-period vibration in theory, the control apparatus often needs a large stroke, thus resulting in an excessively large designed volume of the apparatus, making it difficult to manufacture and install in practical engineering; Third, the existing passive control apparatus are difficult to adjust the period (frequency) after installation and use, and once the damper and the controlled structure are detuned, the control effect will be greatly reduced; Fourth, some existing active or semi-active control technologies have the period (frequency) adjustment function, but the adjustment range is limited, making it difficult to meet the needs of long-period vibration control, and the active and semi-active technologies rely on external energy, and have low stability and robustness; and Fifth, the existing passive control technology cannot achieve the variable-damping function, the control effect is limited, and the control effect is greatly reduced after long-term use.

### Technical Problem

An objective of the embodiments of the present application is to provide an electromagnetic variable-damping latching-based long-period vibration control apparatus, so as to solve the technical problems in the existing art that a traditional vibration control apparatus cannot achieve a variable damping function and is difficult to effectively control long-period vibrations of a structure; that a conventional vibration control apparatus requires a long stroke and a large volume for long-period vibrations, making it difficult to manufacture and install; and that a conventional vibration control apparatus cannot adjust the period (frequency) after design and installation.

### Technical Solution

To achieve the above object, the technical scheme adopted by the application is to provide an electromagnetic variable-damping latching-based long-period vibration control apparatus, including a housing, a rotating shaft, a pendulum mass, a brake assembly, a data acquisition element, an electromagnetic variable-damping module, and a control module. The rotating shaft is in rotational connection with the housing. The pendulum mass is in fixed connection with the rotating shaft. The brake assembly is used for latching the rotating shaft. The data acquisition element is connected with the rotating shaft, and is used for acquiring the rotation angle data of the rotating shaft. The electromagnetic variable-damping module is connected with the rotating shaft, and the rotational damping of the rotating shaft can be adjusted by adjusting the electromagnetic intensity of the electromagnetic variable-damping module. The control module is installed on the housing and includes a data processing unit and a controller. The data processing unit is in electrical connection with the data acquisition element, is used for processing the rotation angle data, and obtains the angular velocity of the pendulum mass. The controller is in electrical connection with the data processing unit, the brake assembly, and the electromagnetic variable-damping module respectively. When the angular velocity acquired by the controller is equal to 0, the controller sends a latching instruction to the brake assembly, and the pendulum mass stops swinging. After the controller completes latching for a latching duration according to different control algorithms, the controller sends an unlatching instruction to the brake assembly, and the pendulum mass resumes swinging.

Optionally, the brake assembly includes a brake disc and a brake caliper. The brake disc is mounted on the rotating shaft. The brake caliper is mounted on the housing. The brake caliper can clamp the brake disc. The brake caliper and the brake disc have a brake clearance therebetween.

Optionally, the brake caliper includes a base, a brake piston, and a friction plate. The base is mounted on the housing, and the base is provided with a groove. One end of the brake piston is connected with a first sidewall 415 of the groove, and the other end of the brake piston is connected with the friction plate. The brake disc is located between the friction plate and a second sidewall 416 of the groove, and the first sidewall 415 and the second sidewall 416 are two parallel and opposite sidewalls.

Optionally, the brake piston is connected with the controller through an oil supply pipeline, and the controller can adjust the oil pressure in the oil supply pipeline to control the movement of the brake piston.

The pendulum mass is connected with the rotating shaft perpendicularly, and the pendulum mass can swing in a plane perpendicular to the rotating shaft.

Optionally, the plate surface of the brake disc is parallel to the swing surface of the pendulum mass and perpendicular to the axis of the rotating shaft.

Optionally, the electromagnetic variable-damping module includes an electromagnetic motor, the electromagnetic motor is coaxially connected with the rotating shaft, the electromagnetic motor is electrically connected with the controller, and the controller can adjust the electromagnetic intensity of the electromagnetic motor.

Optionally, the control module further includes a micro battery, the micro battery is electrically connected with the electromagnetic motor, and the electromagnetic motor can generate part of electric energy stored in the micro battery.

Optionally, the data acquisition element is an encoder.

Optionally, the electromagnetic damping and latching-based long-period vibration control apparatus further includes a bearing. The outer ring of the bearing is connected with the housing, and the inner ring of the bearing is connected with the rotating shaft.

### Beneficial Effect

The electromagnetic damping and latching-based long-period vibration control apparatus has the beneficial effects that:
(1) Compared with the existing art, the electromagnetic variable-damping module is arranged in the application, the damping magnitude of the rotating shaft can be adjusted in real time by changing the electromagnetic intensity of the electromagnetic variable-damping module, and the control effect is ensured.
(2) Compared with the existing art, the brake assembly, the data acquisition element, the data processing unit, and the controller constitute a latching module in the application. The controller sets the latching duration according to a control algorithm, the period of the vibration control apparatus can be extended, the extension range of the period is wide, and the vibration of a long-period or even an ultra-long-period can be controlled better.
(3) Compared with the existing art, in the present application, the latching module can directly extend the period of the vibration control apparatus, so that the period of the pendulum mass can be directly extended without increasing the stroke of the pendulum mass, and the period of the vibration control apparatus can be extended and adjusted to match the period of the controlled structure under the conditions of limited stroke and small volume of the vibration control apparatus.

### BRIEF DESCRIPTION OF DRAWINGS

In order to more clearly illustrate the technical solutions in the embodiments of the present application, the following briefly introduces the drawings required in the embodiments or the existing art description. Obviously, the drawings in the following description merely show some of the embodiments of the present application, and other drawings can be obtained by those skilled in the art without creative efforts.

FIG. 1 is a first schematic diagram of a perspective structure of an electromagnetic variable-damping latching-based long-period vibration control apparatus provided by the embodiment of the present application;

FIG. 2 is a second schematic diagram of another perspective structure of the electromagnetic variable-damping latching-based long-period vibration control apparatus provided by the embodiment of the present application;

FIG. 3 is a schematic diagram of a top view structure of the electromagnetic variable-damping latching-based long-period vibration control apparatus provided by the embodiment of the present application;

FIG. 4 is a schematic diagram of a left view structure of the electromagnetic variable-damping latching-based long-period vibration control apparatus provided by the embodiment of the present application;

FIG. 5 is a sectional view along line A-A in FIG. 3;

FIG. 6 is a schematic diagram of installation of the electromagnetic variable-damping latching-based long-period vibration control apparatus provided by the embodiment of the present application in a controlled structure;

FIG. 7 is a side view of installation of the electromagnetic variable-damping latching-based long-period vibration control apparatus provided by the embodiment of the present application in the controlled structure;

FIG. 8 is an implementation flow chart of the latching module in the electromagnetic variable-damping latching-based long-period vibration control apparatus provided by the embodiment of the present application;

FIG. 9 is a working principle diagram of the latching module in the electromagnetic variable-damping latching-based long-period vibration control apparatus provided by the embodiment of the present application; and

FIG. 10 is a time-history curve of a pendulum mass swing angle of the electromagnetic variable-damping latching-based long-period vibration control apparatus and a traditional control apparatus under a simple harmonic excitation test provided by the embodiment of the present application.

In the drawings, reference numerals are used to refer to the following parts:

10—housing; 20—rotating shaft; 30—pendulum mass; 40—brake assembly; 41—brake caliper; 42—brake disc; 50—control module; 60—electromagnetic motor; 70—data acquisition element; 80—bearing; 90—mounting screw hole; 100—controlled structure.

### DETAILED DESCRIPTION

In order to make the technical problems, technical solutions and beneficial effects of the present application clearer, the present application is further described in detail below with reference to the drawings and embodiments. It should be understood that the specific embodiments described herein are merely illustrative of the present application and are not intended to limit the present application.

It should be noted that when an element is referred to as being “fixed” or “disposed” on another element, it can be directly on the other element or indirectly on the other element. When an element is referred to as being “connected to” another element, it can be directly connected to the other element or indirectly connected to the other element.

It should be understood that the terms “length”, “width”, “upper”, “lower”, “front”, “rear”, “left”, “right”, “vertical”, “horizontal”, “top”, “bottom”, “inner”, “outer” and the like are terms of relative position or location relationship based on the position or location relationship shown in the drawings, and are only for the convenience of describing the present application and simplifying the description, and do not indicate or imply that the apparatus or elements referred to must have a specific position, be constructed and operated in a specific position, and therefore cannot be understood as a limitation on the present application.

In addition, the terms “first”, “second”, etc. are used only for the purpose of description, and cannot be understood as indicating or implying relative importance or implicitly indicating the number of the technical features indicated. Therefore, the features defined with “first”, “second” can explicitly or implicitly include one or more of the features. In the description of the present application, the meaning of “a plurality of” is two or more, unless otherwise specifically limited.

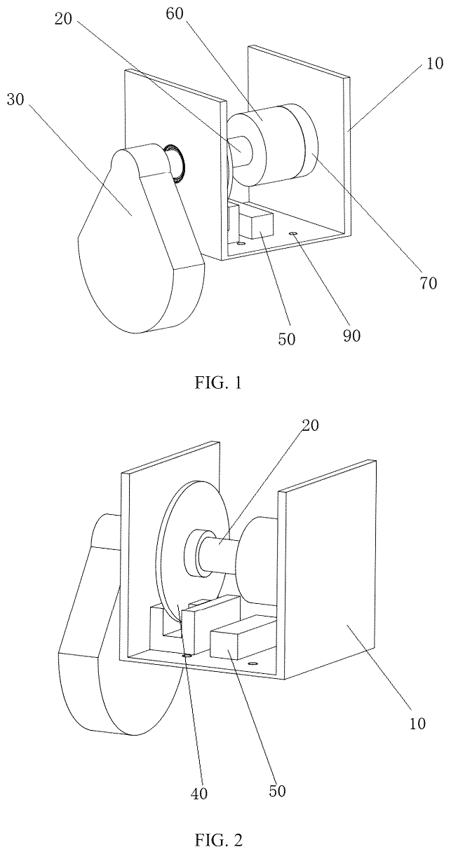

Referring to FIGS. 1 and 2, an electromagnetic variable-damping latching-based long-period vibration control apparatus provided by the embodiment of the present application is described. The electromagnetic variable-damping latching-based long-period vibration control apparatus includes a housing 10, a rotating shaft 20, a pendulum mass 30, a brake assembly 40, a data acquisition element 70, an electromagnetic variable-damping module and a control module 50. The rotating shaft 20 is in rotational connection with the housing 10, and the pendulum mass 30 is in fixed connection with the rotating shaft 20. The brake assembly 40 is used for latching the rotating shaft 20. The data acquisition element 70 is connected with the rotating shaft 20, and is used for acquiring the rotation angle data of the rotating shaft 20. The electromagnetic variable-damping module is connected with the rotating shaft 20, and can adjust the rotational damping of the rotating shaft 20 by adjusting the electromagnetic intensity of the electromagnetic variable-damping module. The control module 50 is mounted on the housing 10, and includes a data processing unit and a controller. The data processing unit is electrically connected to the data acquisition element 70, and is configured to process the rotation angle data and obtain an angular velocity of the pendulum mass 30. The controller is electrically connected to the data processing unit, the brake assembly 40, and the electromagnetic variable-damping module respectively. When the angular velocity acquired by the controller is equal to 0, the controller sends a latching instruction to the brake assembly 40, and the pendulum mass 30 stops swinging. After the controller completes latching for a latching duration according to different control algorithms, the controller sends an unlatching instruction to the brake assembly 40, and the pendulum mass 30 resumes swinging.

In the embodiment, the brake assembly 40, the data acquisition element 70, the data processing unit, and the controller form a latching module, and the latching module can prolong and adjust the period of the vibration control apparatus. The rotating shaft 20 and the pendulum mass 30 form a control force module, and the control force module outputs an effective control force.

Compared with the existing art, the electromagnetic variable-damping latching-based long-period vibration control apparatus provided by the present application has the electromagnetic variable-damping module, the damping of the rotating shaft 20 is adjusted in real time by changing the electromagnetic intensity of the electromagnetic variable-damping module, and the control effect is ensured.

In the embodiment of present application, the brake assembly, the data acquisition element, the data processing unit, and the controller form a latching module. The controller sets the latching duration according to the control algorithm, the period of the vibration control apparatus can be prolonged, the period can be prolonged in a wide range, and the vibration control apparatus has a better control effect on long-period or even ultra-long-period vibration.

In the present application, the latching module can directly prolong the period of the vibration control apparatus, so that the period of the pendulum mass 30 can be directly prolonged without increasing the stroke of the pendulum mass 30, and the period of the vibration control apparatus can be prolonged and adjusted to match the period of the controlled structure under the conditions of limited stroke and small volume of the vibration control apparatus.

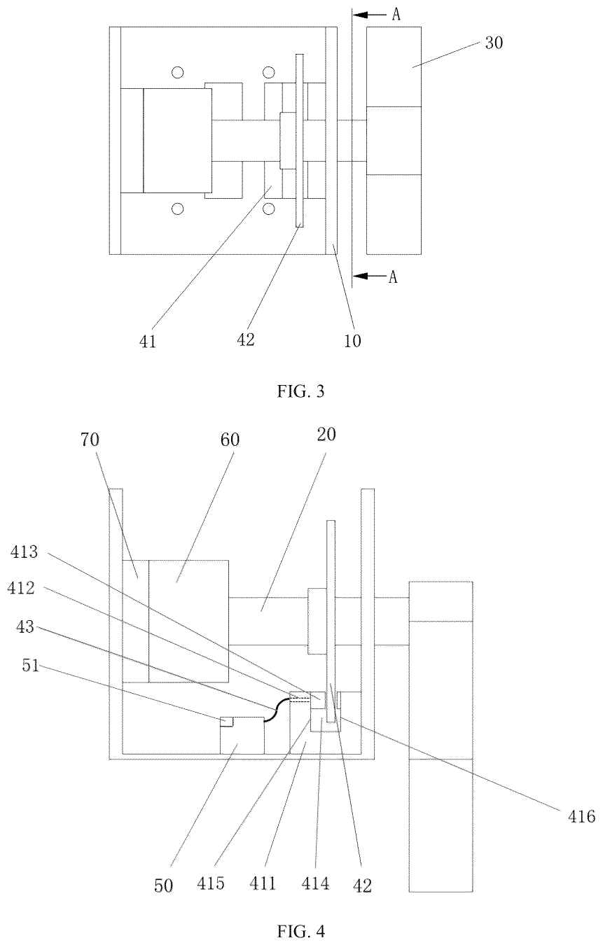

In one embodiment of the present application, referring to FIGS. 3 and 4, the brake assembly 40 includes a brake disc 42 and a brake caliper 41; the brake disc 42 is mounted on the rotating shaft 20; the brake caliper 41 is mounted on the housing 10; the brake caliper 41 can clamp the brake disc 42; and the brake caliper 41 and the brake disc 42 have a brake clearance therebetween.

It can be understood that the brake disc 42 rotates with the rotating shaft 20, and the brake clearance between the brake disc 42 and the brake caliper 41 can avoid the brake caliper 41 from interfering with the rotation of the brake disc 42 when the brake assembly 40 is not working, so that the rotation of the rotating shaft 20 is not affected.

In one embodiment of the application, the brake caliper 41 includes a base 411, a brake piston 412, and a friction plate 413; the base 411 is mounted on the housing 10, and the base 411 is provided with a groove 414; one end of the brake piston 412 is connected with a first side wall of the groove 414, and the other end of the brake piston 412 is connected with the friction plate 413; and the brake disc 42 is located between the friction plate 413 and a second side wall of the groove 414, and the first side wall and the second side wall are two parallel and opposite side walls.

In the embodiment, the brake piston 412 can be extended or shortened, thereby driving the friction plate 413 to move toward or away from the brake disc 42. When the brake piston 412 is extended, the friction plate 413 is moved towards the brake disc, and the brake disc is clamped between the friction plate 413 and the base 411, so that the rotating shaft 20 cannot rotate relative to the housing 10, and the pendulum mass 30 is latched; when the brake piston 412 retracts, the friction plate 413 moves away from the brake disc, the friction plate 413 is separated from the brake disc, and the rotating shaft 20 can continue to rotate relative to the housing 10, and the pendulum mass 30 is unlatched.

In an embodiment of the application, the brake piston 412 is connected with the controller through the oil supply pipeline 43, and the controller can adjust the oil pressure in the oil supply pipeline 43 to control the movement of the brake piston 412.

In an embodiment of the application, the pendulum mass 30 is connected with the rotating shaft 20 perpendicularly, and the pendulum mass 30 can swing in a plane perpendicular to the rotating shaft 20.

In an embodiment of the application, the plate surface of the brake disc 42 is parallel to the swing surface of the pendulum mass 30 and perpendicular to the axis of the rotating shaft 20.

In this embodiment, the plate surface of the brake disc 42 is perpendicular to the axis of the rotating shaft 20, so that when the rotating shaft 20 rotates, the swing of the brake disc 42 in the length direction of the rotating shaft 20 can be reduced, the brake disc 42 is prevented from contacting the friction plate 413 or the base 411, and the rotation of the rotating shaft 20 is ensured to be unaffected.

In an embodiment of the application, referring to FIGS. 1 and 4, the electromagnetic variable-damping module includes an electromagnetic motor 60, which is coaxially connected with the rotating shaft 20, and the electromagnetic motor 60 is electrically connected with the controller, and the controller can adjust the electromagnetic intensity of the electromagnetic motor 60.

In an embodiment of the application, the control module 50 further includes a micro battery 51, which is electrically connected with the electromagnetic motor 60, and the electromagnetic motor 60 can generate part of electric energy to be stored in the micro battery 51.

It can be understood that the micro battery 51 is electrically connected with the controller, and in the process of adjusting the damping, the electromagnetic motor 60 also generates part of electric energy due to the rotation of the rotating shaft 20, and the electric energy is stored in the micro battery 51, thereby providing part of electric energy required by the controller for working.

In this embodiment, the controller can not only control the brake piston 412 but also control the electromagnetic motor 60, thereby ensuring the efficiency of cooperative work of the latching module and the electromagnetic variable-damping module.

In an embodiment of the application, the data acquisition element 70 can be specifically an encoder, which is located at the tail end of the electromagnetic motor 60 and coaxially connected with the rotating shaft 20, and is used for acquiring the rotation angle data of the rotating shaft 20. The rotation angle data may be an angle through which the rotating shaft 20 rotates within a certain period of time.

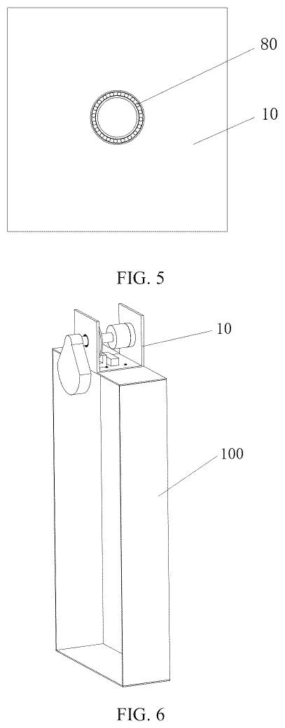

In an embodiment of the present application, referring to FIGS. 1 and 5, the electromagnetic variable-damping latching-based long-period vibration control apparatus further includes a bearing 80, wherein the outer ring of the bearing 80 is connected with the housing 10, and the inner ring of the bearing 80 is connected with the rotating shaft 20.

In this embodiment, the bearing 80 is arranged to support the rotating shaft 20. Additionally, the resistance of the rotating shaft 20 relative to the housing 10 is reduced, the energy loss of the pendulum mass 30 in the swing process is reduced, and the demand of the long-period vibration control is met. Specifically, the bearing 80 can be a ball bearing.

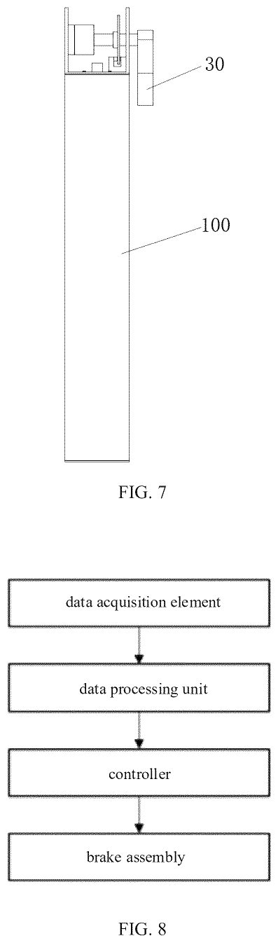

In an embodiment of the application, the electromagnetic variable-damping latching-based long-period vibration control apparatus is mounted on the controlled structure 100. Specifically, referring to FIG. 1, FIG. 6, and FIG. 7, the housing 10 is defined with a mounting screw hole 90, and the housing 10 is connected with the controlled structure 100 by screwing a bolt into the mounting screw hole 90. A control force is generated by the reciprocating swing of the pendulum mass 30 around the rotating shaft 20, and is transmitted to the controlled structure 100 through the housing 10.

In the embodiment, the shape and mass of the pendulum mass are not limited, and the specific shape and mass can be designed according to the required control force of the controlled structure 100.

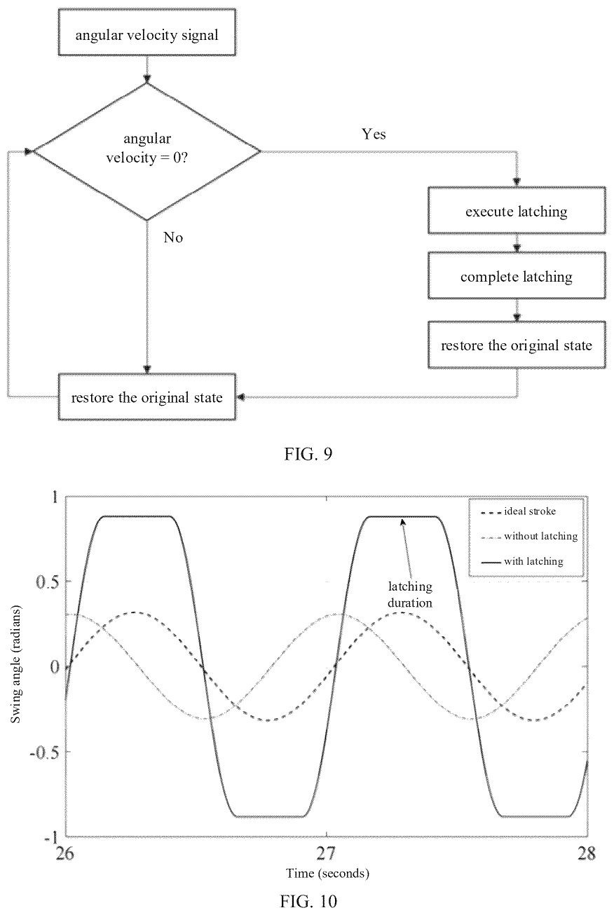

Referring to FIG. 8 and FIG. 9, the working principle of the electromagnetic variable-damping latching-based long-period vibration control apparatus in the embodiment is as follows: the data acquisition element 70 acquires the rotation angle data of the rotating shaft 20, and the rotation angle data is processed by the data processing unit to obtain the angular velocity of the pendulum mass 30. The data processing unit transmits the processed angular velocity signal to the controller. The controller determines the magnitude of the angular velocity signal. When the angular velocity is not equal to 0, the pendulum mass 30 remains working in the original state. When the angular velocity is equal to 0, the controller sends a latching instruction, and the brake assembly 40 executes latching (the brake piston 412 extends, and the friction plate 413 and the base 411 clamp the brake disc 42), so that the pendulum mass 30 is latched and the angular velocity is maintained as 0. After the controller completes latching according to different control algorithms, the controller sends an unlatching command to unlatch the brake assembly 40 (the brake piston 412 retracts, and the friction plate 413 is separated from the brake disc 42), so that the pendulum is released to restore the original motion state.

FIG. 10 schematically shows a comparison of time history curves of a swing angle of the pendulum mass body 30 of the electromagnetic variable-damping latching-based long-period vibration control apparatus provided by an embodiment of the present application and that of a conventional control apparatus under a harmonic excitation test. The ideal stroke of the pendulum angle is the time history curve for generating the best control effect on the controlled structure 100, but this case requires the pendulum length of the pendulum mass body 30 to be too large, and is not applicable to the embodiment. when the pendulum length of the pendulum mass 30 is selected to be a certain value, the traditional control apparatus has no latching module, the phase difference between the pendulum angle stroke and the ideal stroke of the pendulum angle is large, and at this time, no control effect may be generated, and even the vibration response of the controlled structure 100 can be amplified. The vibration control apparatus with the latching module is adopted in the embodiment, and due to the existence of the latching duration, the phase is basically the same as the ideal pendulum angle phase. the horizontal section time history in the figure is the time interval during which latching occurs, at this time, the pendulum angular velocity is maintained as 0, and the pendulum angle is maintained unchanged.

The electromagnetic variable-damping latching-based long-period vibration control apparatus provided by the embodiment of the application can be applied to, but is not limited to, the fields of long-period and super-long-period vibration control, long-period vibration control of floating offshore structures, long-period vibration control of super-high-rise structures, long-period vibration control of large-span flexible structures, long-period vibration control of long pendulum structures, and the like.

The above descriptions are merely preferred embodiments of the present application and are not intended to limit the present application. Any modifications, equivalent substitutions, improvements, and the like made within the spirit and principle of the present application shall be included within the scope of protection of the present application.

1. An electromagnetic variable-damping latching-based long-period vibration control apparatus, comprising:
a housing;
a rotating shaft, rotatably connected with the housing;
a pendulum mass, fixedly connected with the rotating shaft;
a brake assembly, used for latching the rotating shaft;
a data acquisition element, connected with the rotating shaft, and configured for acquiring a rotation angle data of the rotating shaft;
an electromagnetic variable-damping module, connected with the rotating shaft, and capable of adjusting damping of the rotating shaft by adjusting electromagnetic intensity of the electromagnetic variable-damping module; and
a control module, mounted on the housing, and comprising a data processing unit and a controller; wherein the data processing unit is electrically connected with the data acquisition element, and is configured for processing the rotation angle data and obtaining an angular velocity of the pendulum mass; and the controller is electrically connected with the data processing unit, the brake assembly, and the electromagnetic variable-damping module respectively;
wherein
when the angular velocity obtained by the controller is equal to 0, the controller sends a latching instruction to the brake assembly, and the pendulum mass stops swinging; and
after the controller completes latching for a latching duration according to different control algorithms, the controller sends an unlatching instruction to the brake assembly, and the pendulum mass resumes swinging.

2. The electromagnetic variable-damping latching-based long-period vibration control apparatus according to claim 1, wherein the brake assembly comprises:
a brake disc, mounted on the rotating shaft; and
a brake caliper, mounted on the housing;
wherein
the brake caliper is capable of clamping the brake disc; and
a brake clearance is provided between the brake caliper and the brake disc.

3. The electromagnetic variable-damping latching-based long-period vibration control apparatus according to claim 2, wherein the brake caliper comprises a base, a brake piston, and a friction plate;
wherein
the base is mounted on the housing, and the base is provided with a groove; one end of the brake piston is connected with a first side wall of the groove, and
the other end of the brake piston is connected with the friction plate; and the brake disc is located between the friction plate and a second side wall of the groove, and the first side wall and the second side wall are two parallel and opposite side walls.

4. The electromagnetic variable-damping latching-based long-period vibration control apparatus according to claim 3, wherein the brake piston is connected with the controller through an oil supply pipeline, and the controller is capable of adjusting an oil pressure in the oil supply pipeline to control movement of the brake piston.

5. The electromagnetic variable-damping latching-based long-period vibration control apparatus according to claim 1, wherein the pendulum mass is connected to the rotating shaft perpendicularly and is able to swing in a plane perpendicular to the rotating shaft.

6. The electromagnetic variable-damping latching-based long-period vibration control apparatus according to claim 2, wherein a plate surface of the brake disc is parallel to a swing plane of the pendulum mass and perpendicular to an axis of the rotating shaft.

7. The electromagnetic variable-damping latching-based long-period vibration control apparatus according to claim 6, wherein the electromagnetic variable-damping module comprises an electromagnetic motor connected to the rotating shaft coaxially, the electromagnetic motor is electrically connected to the controller, and the controller is able to adjust the electromagnetic intensity of the electromagnetic motor.

8. The electromagnetic variable-damping latching-based long-period vibration control apparatus according to claim 7, wherein the control module further comprises a micro battery electrically connected to the electromagnetic motor, and the electromagnetic motor is able to generate part of electric energy stored in the micro battery.

9. The electromagnetic variable-damping latching-based long-period vibration control apparatus according to claim 1, wherein the data acquisition element is an encoder.

10. The electromagnetic variable-damping latching-based long-period vibration control apparatus according to claim 1, further comprising a bearing, an outer ring of the bearing being connected to the housing, and an inner ring of the bearing being connected to the rotating shaft.

11. The electromagnetic variable-damping latching-based long-period vibration control apparatus according to claim 2, further comprising a bearing, an outer ring of the bearing being connected to the housing, and an inner ring of the bearing being connected to the rotating shaft.

12. The electromagnetic variable-damping latching-based long-period vibration control apparatus according to claim 3, further comprising a bearing, an outer ring of the bearing being connected to the housing, and an inner ring of the bearing being connected to the rotating shaft.

13. The electromagnetic variable-damping latching-based long-period vibration control apparatus according to claim 4, further comprising a bearing, an outer ring of the bearing being connected to the housing, and an inner ring of the bearing being connected to the rotating shaft.

14. The electromagnetic variable-damping latching-based long-period vibration control apparatus according to claim 5, further comprising a bearing, an outer ring of the bearing being connected to the housing, and an inner ring of the bearing being connected to the rotating shaft.

15. The electromagnetic variable-damping latching-based long-period vibration control apparatus according to claim 6, further comprising a bearing, an outer ring of the bearing being connected to the housing, and an inner ring of the bearing being connected to the rotating shaft.

16. The electromagnetic variable-damping latching-based long-period vibration control apparatus according to claim 7, further comprising a bearing, an outer ring of the bearing being connected to the housing, and an inner ring of the bearing being connected to the rotating shaft.

17. The electromagnetic variable-damping latching-based long-period vibration control apparatus according to claim 8, further comprising a bearing, an outer ring of the bearing being connected to the housing, and an inner ring of the bearing being connected to the rotating shaft.

18. The electromagnetic variable-damping latching-based long-period vibration control apparatus according to claim 9, further comprising a bearing, an outer ring of the bearing being connected to the housing, and an inner ring of the bearing being connected to the rotating shaft.
